(19) United States
(12) Patent Application Publication
(10) Pub. No.: US 2009/0130261 A1
(43) Pub. Date: May 21, 2009

(54) Vit-A-Cup

(76) Inventors: Gary D. Rich, Revere, MA (US); Philip Robert Stone, Phoenix, NY (US)

Correspondence Address: Daniel N. Smith, 15 Church Street, Salem, MA, 01970, US

(21) Appl. No.: 12/274,363

(22) Filed: Nov. 20, 2008

Related U.S. Application Data
(60) Provisional application No. 60/989,431, filed on Nov. 20, 2007.

(51) Int. Cl. B65D 85/72; A23L 1/302; A23L 1/303

(52) U.S. Cl. 426/66; 426/72; 426/73

(57) ABSTRACT

A nutritional supplement dispensing system containing a disposable liquid container with a base matrix made of consumable vitamin and mineral supplements. A user of the system may add water or another liquid to the base matrix in the container to create a drink mixture for consumption of nutritional vitamins and minerals.

### CROSS REFERENCE TO RELATED APPLICATION

This application claims the benefit of U.S. Provisional Patent Application No.: 60/989,431 filed on Nov. 20, 2007, the contents of which are incorporated herein by reference.

### FIELD OF THE INVENTION

The present invention relates to a disposable nutritional supplement delivery system for correcting dietary deficiencies of vitamins and minerals.

### BACKGROUND OF INVENTION

Most consumers in today's environment of fast food restaurants and pre-packaged meals fail to intake a healthy amount of vitamins and minerals in their diets. Despite the wide publication of such information from the medical community, very few people consume the recommended daily allowance of fruits and vegetables. Thus, the health of many people has deteriorated rapidly resulting in epidemics of obesity and diabetes.

Conventional multivitamins pills or tablets can supplement the diet of individuals, but their use is limited. Many individuals do not want to take any (or additional) capsules or tablets during the course of their day. In addition, many individuals find it difficult to ingest capsules or tablets.

Nutritional supplements in the form of edible food, such as protein bars or shakes, allow people to ingest nutritional supplements without the unpleasant experience of ingesting tablets. However, many of these supplements are sold in limited categories of taste. Many of these tastes are unpleasant and undesirable.

A new type of nutritional supplement delivery system is needed that can be modified by the consumer to contain a variety of tastes, subject to the preferences of the consumer. In addition, a light weight supplement delivery system would reduce shipping costs.

### SUMMARY OF THE INVENTION

The subject invention discloses a nutritional supplement dispensing system comprising: a disposable liquid container; an opening on top of the disposable liquid container; a base matrix inserted into the disposable container, wherein the base matrix comprises at least one consumable vitamin supplement, one consumable mineral supplement or one consumable medicinal supplement; wherein the disposable liquid container further comprises a detachable cover over the opening, further wherein the detachable cover is removed and a consumable liquid is added to the base matrix, wherein the opening allows ingestion of the base matrix and consumable liquid from the disposable liquid container.

In one embodiment of the subject invention the consumable liquid comprises water.

In another embodiment of the subject invention the disposable liquid container comprises a size that holds 2 fluid ounces to 100 fluid ounces of consumable liquid.

In a further embodiment of the subject invention the disposable liquid container comprises a size that holds 12 fluid ounces of consumable liquid.

In one embodiment of the subject invention disposable liquid container comprises a size that holds 20 fluid ounces of consumable liquid.

In a further embodiment of the subject invention the disposable liquid container comprises a size that holds 0.5 liters to 4 liters of consumable liquid.

In another embodiment of the subject invention the disposable liquid container comprises a size that holds 1 liter of consumable liquid.

In one embodiment of the subject invention the disposable liquid container comprises a size that holds 2 liters of consumable liquid.

In another embodiment of the subject invention the base matrix is inserted into the disposable liquid container by a method selected from the group consisting of drop-dosing and spray coating.

In a further embodiment of the subject invention the base matrix is maintained outside the disposable liquid container in a separate packaging unit.

In one embodiment of the subject invention the consumable vitamin supplement is selected from the group consisting of Vitamin A, Vitamin B, Vitamin B, Vitamin B2, Vitamin B3, Vitamin B5, Vitamin B6, Vitamin B12, Biotin, Choline, Folic Acid, Inositol, PABA, Vitamin C, Vitamin D, Vitamin E, Vitamin K, Bioflavinoids, and Coenzyme Q10.

In another embodiment of the subject invention the consumable mineral supplement is selected from the group consisting of Calcium, Chromium, Copper, Iodine, Iron, Magnesium, Manganese, Molybdenum, Potassium, Selenium, and Zinc. In a further embodiment of the subject invention the disposable liquid container is composed of a material selected from the group consisting of paper, paper stock, paperboard, Styrofoam, Polystyrene, and Polycarbonate.

In one embodiment of the subject invention the detachable cover is composed of a material selected from the group consisting of metal foil, paper, and plastic.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates a perspective view of a cup of the subject invention with a closed removable lid over the top.

FIG. 2 illustrates a perspective cross-sectional view of a cup of the subject invention with the lid removed and no liquid added.

FIG. 3 illustrates a perspective cross-sectional view of a cup of the subject invention with the lid removed and with liquid being added.

FIG. 4 illustrates a perspective cross-sectional view of a cup of the subject invention with the lid removed and liquid mixed with the contents of the cup.

### DETAILED DESCRIPTION OF THE PREFERRED EMBODIMENTS

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

The disclosed invention comprises a pre-manufactured disposable liquid container, such as a cup, containing a water soluble consumable vitamin supplement, multi-vitamin supplement, mineral supplement or any combination thereof. In an alternative embodiment of the subject invention, the liquid container may contain a consumable liquid vitamin supplement or multivitamin supplement. In another embodiment of the subject invention, the liquid container may contain a water soluble consumable medicine.

The disposable liquid container of the subject invention may further comprise a type of liquid hardener to be mixed with the consumable vitamin or consumable mineral so that they will adhere or stay in the liquid container until they are mixed with a liquid.

In one embodiment of the subject invention the consumable vitamin supplement or consumable mineral supplement is inserted into the disposable liquid container by a method of drop-dosing or spray coating.

In a further embodiment of the subject invention, the consumable vitamin supplement, consumable multivitamin supplement or consumable mineral supplement may be colorless, odorless or tasteless.

In one embodiment of the subject invention, the liquid container may be manufactured to contain hot or cold beverages. In another embodiment of the subject invention, the liquid container may be manufactured to be microwaveable. In a further embodiment of the subject invention, the liquid container may also be manufactured to be chilled.

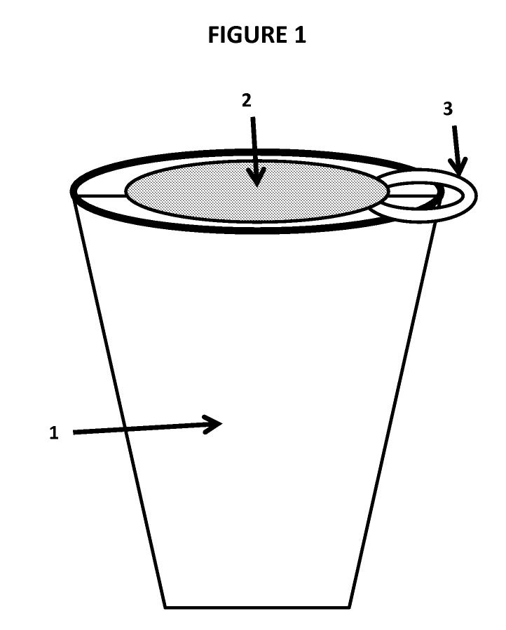

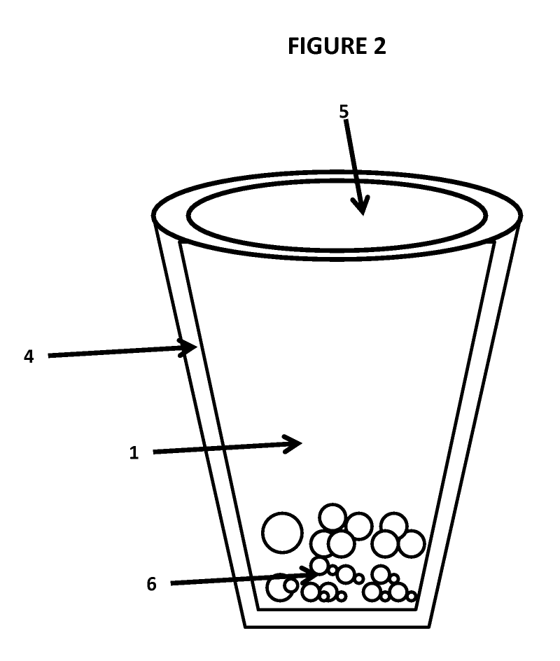

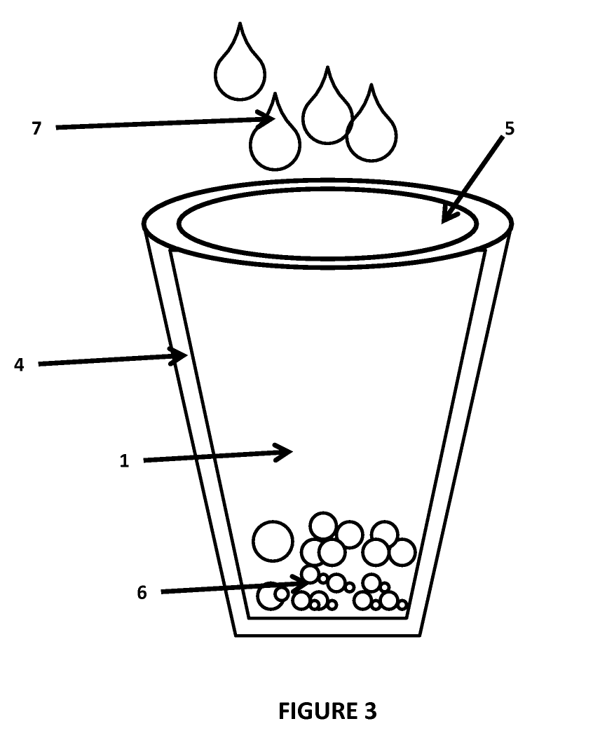

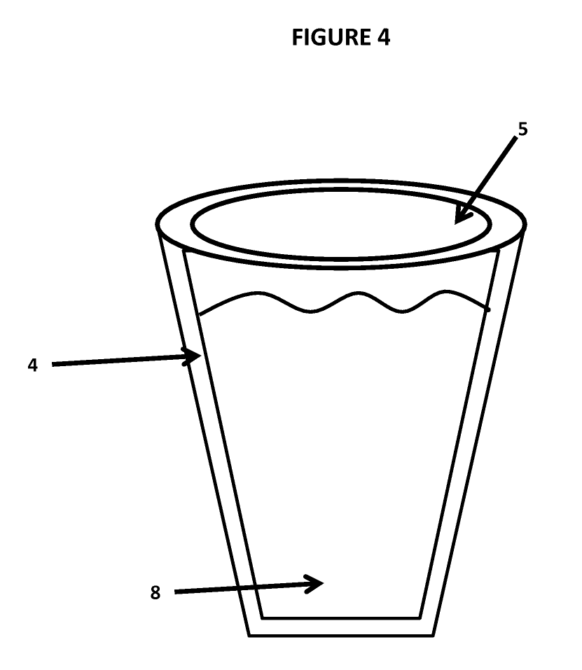

FIGS. 1 to 4 illustrate one embodiment of the subject invention. Cup 1 contains a dry base matrix 6 of nutrients, such as consumable vitamin supplements and consumable mineral supplements. Cup 1 is packaged and sold to users containing only the dry base matrix 6 of nutrients and no liquid. In such packaging, Cup 1 will have a light weight for shipping or sale.

Cup 1 is packaged and sold to users with a removable lid 2 covering cup top opening 5. Removable lid 2 may contain a clasp or tab 3 for removing the removable lid 2 to expose cup top opening 5. Once the removable lid 2 is removed, a user may add a liquid 7 through cup top opening 5 to the dry base matrix 6 in the cup 1. The liquid 7 and the base matrix 6 mix to form the drinkable nutritional mixture 8. Cup top opening 5 is designed to allow a user to ingest nutritional mixture 8 straight from cup 1.

In one embodiment of the subject invention, cup 1 may also comprise insulated material 4 for keeping the nutritional mixture 8 either cold or hot as desired by the user.

In another embodiment of the subject invention, the cup 1 may be comprised of different materials known to those skilled in the art, including, but not limited to: paper, lined and unlined paper stock, paperboard, waxed paperboard, Styrofoam, Polystyrene, Polycarbonate, or other material suitable to contain fluid.

In one embodiment of the subject invention, the liquid 7 comprises water.

In a further embodiment of the subject invention, the cup 1 may comprise various sizes to hold 2 fluid ounces to 100 fluid ounces of consumable liquid 7.

In another embodiment of the subject invention, the removable lid 2 may be comprised of different materials known to those skilled in the art, including, but not limited to: metal foils, paper, and plastics.

In a further embodiment of the subject invention, the tab 3 may be comprised of various designs known to those skilled in the art, including, but not limited to: tabs, clasps, clips, fasteners, ties, snaps, hooks, flaps, strips or ribbons.

In one embodiment of the subject invention, the base matrix 6 may contain either single or multiple consumable vitamin supplements; single or multiple consumable mineral supplements, or any combination thereof. In another embodiment of the subject invention, the consumable vitamin supplement may comprise, but is not limited to: Vitamin A (Beta-Carotene), Vitamin B (individually and/or as a complex), Vitamin B1 (Thiamine), Vitamin B2 (Riboflavin), Vitamin B3 (Niacin), Vitamin B5 (Pantothenic Acid), Vitamin B6 (Pyridoxine), Vitamin B12 (Cyanocobalamin), Biotin, Choline, Folic Acid, Inositol, PABA (Para-Aminobenzoic Acid), Vitamin C (Ascorbic Acid), Vitamin D, Vitamin E, Vitamin K, Bioflavinoids, Coenzyme Q10 and any combination thereof.

In another embodiment of the subject invention, the consumable mineral supplement may comprise, but is not limited to: Calcium, Chromium, Copper, Iodine, Iron, Magnesium, Manganese, Molybdenum, Potassium, Selenium, and Zinc and any combination thereof.

The VITACUP Product consists primarily of disposable cup composed of any suitable commercially available materials to include but not be limited to paper, lined and unlined paper stock, paperboard, waxed paperboard, Styrofoam, Polystyrene, Polycarbonate, or other material suitable to contain fluid. Various base carrier matrices containing various consumable vitamin and mineral supplements will be added to the cup. These supplements include but are not limited to Vitamins: A (Beta-Carotene), B (individually and/or as a complex), B1 (Thiamine), B2 (Riboflavin), B3 (Niacin), B5 (Pantothenic Acid), B6 (Pyridoxine), B12 (Cyanocobalamin), Biotin, Choline, Folic Acid, Inositol, PABA (Para-Aminobenzoic Acid), C (Ascorbic Acid), D, E, K, Bioflavinoids, Coenzyme Q10, as well as minerals or multi-mineral blends to include but not be limited to Calcium, Chromium, Copper, Iodine, Iron, Magnesium, Manganese, Molybdenum, Potassium, Selenium, and Zinc. Via either drop-dosing or spray coating, the interior of the cup will be coated with these various matrices. The end consumer will add their own liquid beverage product to the cup, into which the matrix and the supplements will be dissolved.

The differing chemical characteristics of the various additives require each ingredient or blend of ingredients to be dissolved or suspended in a customized matrix in order to ensure desired delivery of the additive in question. Further, some raw materials require micro-encapsulation to prevent degradation and retain the desired bioavailability. A number of characteristics were studied for each desired additive compound or complex, such as the degree of chemical affinity to water, solubility rates in various solvents and at various levels of pH, and degradation rates upon exposure to various environmental factors including oxygen levels in ambient air and temperature, as well as individual tolerance to extreme shifts in pH levels. More hydrophilic additives are compatible with a starch or carbomer-based matrix, while some hydrophobic additives required formation of a suspension in hydroxyethylcellulose or hydroxymethylcellulose bases.

Flavor factored heavily into the development of these additive blends as well, as the palatability of the end product is of paramount concern. The baseline flavor profile of each additive or additive blend was evaluated for taste, and masking flavors were created where required for each additive blend that was to be incorporated into the various carrier matrices, with specific focus on only masking the undesirable flavors of the raw materials, and not imparting any overt flavor notes to the fluid beverage product the end consumer added to the product.

The VITACUP product delivers the US RDA (United States Recommended Daily Allowance) of each of the various vitamin and mineral additives within the specified dose of the individual VITACUP product in question. More palatable and water-soluble additives may be dosed into smaller unit sizes, while less soluble or less palatable raw materials may require dissolution into a larger amount of fluid beverage. VITACUP has compatibility across a wide range of consumer beverage choices, with little to no noticeable flavors imparted by the additives themselves, and will no loss of nutrient bioavailability.

Vitamins A (Beta-Carotene), B1 (Thiamine), B2 (Riboflavin), B3 (Niacin), B5 (Pantothenic Acid), B6 (Pyridoxine), and B12 (Cyanocobalamin), as well as Biotin, Choline, and a number of essential and non-essential amino acids such as Alanine, Asparagine, Aspartic acid, Arginine, Cysteine, Glutamine, Glycine, Glutamic acid, Histidine, Isoleucine, Lysine, Leucine, Phenylalanine, Methionine, Serine, Proline, Tryptophan, Threonine, Tyrosine, and Valine, when dissolved or suspended in water-based polyacrylic acid carbomer matrixes, were shown to be both compatible in the short term as well as stable over the longer term.

A typical formulation for a B-Complex VITACUP would deliver 1.2 mg of Thiamine (Vitamin B1), 1.4 mg of Riboflavin (Vitamin B2), 15 mg of Niacin (Vitamin B3), 2 mg of Pyridoxine (Vitamin B6), and 2 mg of Cyanocobalamin (Vitamin B12) in a 22% modified starch base. Note the US RDA and solubility characteristics of the various vitamins and minerals listed in the table below.

| | Men | | Women | |
|---|---|---|---|---|
| Nutrient | RDA | SONA | RDA | SONA |

Fat-soluble Vitamins

| | | | | |
|---|---|---|---|---|
| Vitamin A (RE, I RE = I micro | 1,000 | 2,000 | 800 | 2,000 |
| gm = 3.33 IU) | | | | |
| Beta-carotene (mg) | N/A | 100 | N/A | 80 |
| Vitamin D (micro gm, 1 | 5 | 24 | 5 | 24 |
| microgram = 40 IU) | | | | |
| Vitamin E (IU, 1 IU alpha tocopherol | 10 | 800 | 8 | 800 |
| equivalent to I mg alpha tocopherol) | | | | |
| Vitamin K (mg) | 80 | 80 | 65 | 65 |

RDA = Recommended Daily Allowance; SONA = Suggested Optimal Daily Allowance

WATER-SOLUBLE VITAMINS

| | | | | |
|---|---|---|---|---|
| Vitamin C (mg) | 60 | 800 | 60 | 1000 |
| Vitamin B12 (mg) | 2 | 3 | 2 | 3 |
| Folic acid (micro gm) | 200 | 2000 | 180 | 2000 |
| Niacin (mg) | 15 | 30 | 15 | 25 |
| Pyridoxine (B6) (mg) | 2 | 25 | 1.6 | 20 |
| Riboflavin (B 2) (mg) | 1.4 | 2.5 | 1.2 | 2 |
| Thiamin (B1) (mg) | 1.2 | 9.2 | 1 | 9 |

MINERALS

| | | | | |
|---|---|---|---|---|
| Boron (mg) | N/A | 2.5 | N/A | 3 |
| Calcium (mg) | 800 | 700 | 800 | 1200 |
| Chromium (micro gm) | 50-200 | 300 | 50-200 | 300 |
| Copper (mg) | 1.5-3 | 1.5-4 | 1.5-3 | 1.5-4 |
| Iodine (micro gm) | 150 | 150 | 150 | 150 |
| Iron (mg) | 10 | 20 | 15 | 20 |
| Magnesium (mg) | 350 | 600 | 280 | 550 |
| Manganese (mg) | 2-5 | 10 | 2-5 | 10 |
| Phosphorous (mg) | 800 | 800 | 800 | 800 |
| Potassium (mg) | 99 | 200-500 | 99 | 200-500 |
| Selenium (micro gm) | 70 | 250 | 55 | 200 |
| Sodium (mg) | 500 | 400 | 500 | 400 |
| Zinc (mg) | 15 | 20 | 12 | 17 |

Insoluble compounds such as Folic Acid, Inositol, PABA (Para-Aminobenzoic Acid), Vitamin C (Ascorbic Acid), Vitamins D, E, and K, as well as some bioflavinoids, Coenzyme Q10, and most minerals or multi-mineral blends to include but not be limited to Calcium, Chromium, Copper, Iodine, Iron, Magnesium, Manganese, Molybdenum, Potassium, Selenium, and Zinc require suspension prior to administration to the cup itself. This is accomplished, for example, in a suspension of 3% Xanthan gum and 0.5% Noveon Carbopol Carbomer in distilled water with 20% Ethanol (to aid in speeding the drying time). This solution is then sprayed on to the interior of the cup and allowed to dry. A typical formulation for a nearly-RDA multi-mineral VITACUP would deliver 800 mg of Calcium, 100 μg of Chromium, 2 mg of Copper, 150μ of Iodine, 10 mg of Iron, 350 mg of Magnesium, 3 mg of Manganese, 800 mg of Phosphorus, 90 mg of Potassium, 70 μg of Selenium, 400 mg of Sodium and 15 mg of Zinc. Again, this would be delivered in a flavor-masked suspension of 3% Xanthan gum and 0.5% Noveon Carbopol Carbomer.

For additives or blends that pose solubility issues, we can force some of the desired additives into compatibility with the system, by adjusting the pH of the suspension, but there are a number of considerations that must be taken into account with regard to how these compounds will react upon rehydration in the beverage choice of the end product consumer.

pH is a logarithmic measure of the hydrogen ion concentration in a given material. In lay terms, the hydrogen ion concentration in pure water around room temperature is about 1.0×10⁻⁷ M. A pH of 7 is considered “neutral”, because the concentration of hydrogen ions is exactly equal to the concentration of hydroxide (OH⁻) ions produced by dissociation of the water. Increasing the concentration of hydrogen ions above 1.0×10⁻⁷ M produces a solution with a pH of less than 7, and the solution is considered “acidic”. Decreasing the concentration below 1.0×10⁻⁷ M produces a solution with a pH above 7, and the solution is considered “alkaline” or “basic”.

pH is often used to compare solution acidities. For example, a solution of pH 1 is said to be 10 times as acidic as a solution of pH 2, because the hydrogen ion concentration at pH 1 is ten times the hydrogen ion concentration at pH 2. This is correct as long as the solutions being compared both use the same solvent. It is misleading to compare relative acidities in differing solvents because the neutral pH of the material in question is different for each solvent. For example, the concentration of hydrogen ions in pure ethanol is about 1.58×10⁻¹⁰ M, so ethanol is neutral at pH 9.8. A solution with a pH of 8 would be considered acidic in ethanol, but basic in water. The various desired additive materials react and absorb differently at various pH levels, and thus as pH is critical in the solubility of the raw additive materials as well as that of the carrier, this plays into the solubility of the finished product with regard to the consumer use of the cup when rehydrating the dried carrier matrix. For the purposes of this discussion, we will assume the beverages to be used in the VITACUP end product will be water-based.

As can be seen in the table presented below, to create a stable, compatible product that will deliver nutrient value across a wide range of beverage choices some raw nutrient additives require special coatings to protect them from hostile pH environments, which allow them to be incorporated into various base matrixes (specialized to the specific additive blend), and still retain their bioavailability and be able to deliver their nutrient value to the consumer.

The table below represents pH values for some common fluid beverages:

| Beverage Product | Associated pH Value (or range) |
|---|---|
| Apple juice | 2.9-3.3 |
| Distilled water | 7.0 |
| Drinking water | 6.5-8 |
| Grape Juice | 3.5-4.5 |
| Grapefruit juice | 3-3.3 |
| Lemon juice | 2.3 |
| Lime Juice | 1.8-2 |
| Orange juice | 3-4 |
| Cow's Milk | 6.4 |
| Cola | 2.9-3.3 |
| Strawberry Juice | 3.0-3.5 |
| Tomato juice | 4.2 |

The VITACUP platform also includes versions specifically targeted at competing with herbal supplements currently on the market in capsule form. These would include, but not be limited to, blends of herbals intended to aid in weight loss and appetite suppression, relief from digestive problems, natural relief from anxiety, as well as natural, herbal sleep remedies.

What is claimed is:

1. A nutritional supplement dispensing system comprising: a disposable liquid container; an opening on top of the disposable liquid container; a base matrix inserted into the disposable container, wherein the base matrix comprises at least one consumable vitamin supplement, one consumable mineral supplement or one consumable medicinal supplement; wherein the disposable liquid container further comprises a detachable cover over the opening, further wherein the detachable cover is removed and a consumable liquid is added to the base matrix, wherein the opening allows ingestion of the base matrix and consumable liquid from the disposable liquid container.

2. The nutritional supplement dispensing system of claim 1, wherein the consumable liquid comprises water.

3. The nutritional supplement dispensing system of claim 1, wherein the disposable liquid container comprises a size that holds 2 fluid ounces to 100 fluid ounces of consumable liquid.

4. The nutritional supplement dispensing system of claim 1, wherein the disposable liquid container comprises a size that holds 12 fluid ounces of consumable liquid.

5. The nutritional supplement dispensing system of claim 1, wherein the disposable liquid container comprises a size that holds 20 fluid ounces of consumable liquid.

6. The nutritional supplement dispensing system of claim 1, wherein the disposable liquid container comprises a size that holds 0.5 liters to 4 liters of consumable liquid.

7. The nutritional supplement dispensing system of claim 1, wherein the disposable liquid container comprises a size that holds 1 liter of consumable liquid.

8. The nutritional supplement dispensing system of claim 1, wherein the disposable liquid container comprises a size that holds 2 liters of consumable liquid.

9. The nutritional supplement dispensing system of claim 1, wherein the base matrix is inserted into the disposable liquid container by a method selected from the group consisting of drop-dosing and spray coating.

10. The nutritional supplement dispensing system of claim 1, wherein the base matrix is maintained outside the disposable liquid container in a separate packaging unit.

11. The nutritional supplement dispensing system of claim 1, wherein the consumable vitamin supplement is selected from the group consisting of Vitamin A, Vitamin B, Vitamin B, Vitamin B2, Vitamin B3, Vitamin BS, Vitamin B6, Vitamin B12, Biotin, Choline, Folic Acid, Inositol, PABA, Vitamin C, Vitamin D, Vitamin E, Vitamin K, Bioflavinoids, and Coenzyme Q10.

12. The nutritional supplement dispensing system of claim 1, wherein the consumable mineral supplement is selected from the group consisting of Calcium, Chromium, Copper, Iodine, Iron, Magnesium, Manganese, Molybdenum, Potassium, Selenium, and Zinc.

13. The nutritional supplement dispensing system of claim 1, wherein the disposable liquid container is composed of a material selected from the group consisting of paper, paper stock, paperboard, Styrofoam, Polystyrene, and Polycarbonate.

14. The nutritional supplement dispensing system of claim 1, wherein the detachable cover is composed of a material selected from the group consisting of metal foil, paper, and plastic.
